(19) United States
(12) Patent Application Publication
(10) Pub. No.: US 2005/0117159 A1
(43) Pub. Date: Jun. 2, 2005

(54) Polarization diversity detection using a polarization multiplexed local oscillator

(76) Inventor: Harald Rosenfeldt, Hamburg (DE)

Correspondence Address: PERMAN & GREEN, 425 POST ROAD, FAIRFIELD, CT, 06824, US

(21) Appl. No.: 10/500,981

(22) PCT Filed: Jun. 29, 2002
(86) PCT No.: PCT/EP02/07198

(51) Int. Cl. G01B 9/02

(52) U.S. Cl. 356/477

(57) ABSTRACT

Determining properties of an optical device under test (ODUT), includes: splitting an incoming light beam into first and second light beams, coupling the first light beam into the ODUT, letting the second light beam travel a different path as the first light beam, splitting the second light beam into first and second parts, delaying the second part of the second light beam relative to the first part of the second light beam, recombining the first and the second parts of the second light beam, superimposing the first light beam and the recombined second light beam to produce interferences between the first light beam and the recombined second light beam in at least one resulting superimposed light beam as a function of frequency and polarization when tuning the frequency of the incoming light beam over a given range, deriving the optical property of the ODUT from the frequency dependence of the detected powers.

### BACKGROUND OF THE INVENTION

The present invention relates to determination of an optical property of an optical device under test, in particular to optical polarization diversity detection.

### SUMMARY OF THE INVENTION

It is an object of the invention to provide improved optical polarization diversity detection.

The object is solved by the independent claims.

The prior art measuring concept according to EP 1113250 acquired the Jones matrix elements of a DUT by using a laser signal which was swept in wavelength as stimulus. The output signal was analyzed by a coherent superposition with a LO signal. To provide polarization resolved measurement the output signal was split into two orthogonal components each of which were superimposed with the LO signal. To unambiguously acquire all 4 elements of the Jones matrix it was necessary to perform this measurement with two input polarization states. Therefore it was either necessary to perform an extra wavelength sweep or to insert a PDU into the DUT path allowing to stimulate the DUT with two polarization states ‘simultaneously’ according to U.S. Ser. No. 09/941,133.

In an embodiment of the present invention it is proposed to insert a PDU according to U.S. Ser. No. 09/941,133, the disclosure of which is incorporated herein by reference, into the LO path (PDU_{LO}) so that two orthogonal polarization states, a first state of polarization (SOP_{H}) and a second state of polarization (SOP_{V}), occur at the output of the PDU_{LO}. The two orthogonal components have traveled different optical paths inside the PDU and thus produce interference signatures at different electrical frequencies (f_{H} and f_{V}) when combined with the DUT signal at the detector.

Therefore, in an embodiment of the present invention it is disclosed an enhancement of the interferometric measurement method of EP 1113250, the disclosure of which is incorporated herein by reference, which is able to measure the chromatic dispersion (CD) and polarization mode dispersion (PMD) of a device under test (DUT) with high accuracy. According to an embodiment of the present invention the use of a polarization delay unit (PDU) according to U.S. Ser. No. 09/941,133 in the local-oscillator (LO) path of the DUT interferometer allows to replace the polarization diversity detector (PDR) by a single detector to reduce complexity of the detection scheme. In this way, problems associated with detector symmetry and extinction ratio of the polarization beam splitter (PBS) can be solved since there is only one detector left so that the PBS can be omitted.

The interference signatures created by the interference of the DUT signal with SOP_{H} and SOP_{V} respectively can be distinguished preferably by applying band pass filters of appropriate center frequency and bandwidth.

Furthermore, amplitude and phase of the two spectral components only depend on the fraction of the DUT signal having the same polarization as the interfering LO signal. That is, the DUT signal is inherently decomposed into two polarizations SOP_{H} and SOP_{V} interfering with the corresponding two LO signals and producing signatures at f_{H} and f_{V} respectively. In an embodiment of the present invention the AC part of the detector signal can be written as follows:

$$\begin{matrix}{P}_{AC} ( ω ) = {E}_{LO} {E}_{DUT} ( {\vec{sop}}_{DUT} \cdot {\vec{sop}}_{H} ) cos ( {φ}_{H} + {( {τ}_{DUT} - {τ}_{LO , H} )}_{{1 \; 4 \; 4 \; 2 \; 4 \; 43 }_{{f}_{H}}} ω ) + \\ {E}_{LO} {E}_{OUT} ( {\vec{sop}}_{DUT} \cdot {\vec{sop}}_{V} ) cos ( {φ}_{V} + {( {τ}_{DUT} - {τ}_{LO , V} )}_{{1 \; 4 \; 4 \; 2 \; 4 \; 43 }_{{f}_{V}}} ω )\end{matrix}$$

Hence, the polarization dependence of the interference effect can be used to realize polarization diversity detection and the information contained in the two signatures is equivalent to a prior art PDR output according to EP 1113250.

To produce a signal which can be processed in the established way by the Jones matrix eigenanalysis, the two spectral components can be separated using two bandpass filters (possibly FIR filters). Then the faster oscillating signal can be shifted in frequency so that it is aligned to the slower oscillating signal. This can easily be achieved if the differential group delay (DGD) of the PDU (DGD_{PDU}=τ_{LO,H}−τ_{LO,V}) is known. Then a linear phase term can be subtracted from the analytical signal by multiplying with exp(−(τ_{LO,H}−τ_{LO,V})ω). Now the two generated signals are identical to those which would have been generated by a coherent prior art PDR detector.

Furthermore, the prior art concepts incorporating PDRs as detectors suffered from the fact that it is very difficult to choose an optimum LO polarization at more than two PDRs simultaneously. This problem can be solved by an embodiment of the present invention since the polarization of the LO signal does not enter the evaluation anymore. This property makes this embodiment particularly well suited for multiport device characterization where the LO is distributed among several detectors.

Using the prior art concept according to EP 1113250 for multiport device characterization requires distributing the LO signal among several PDR detectors. Unfortunately it is very difficult to provide an optimum input polarization of the LO signal at every PDR simultaneously simply by adjusting the input polarization of the whole setup. Therefore, with the cited prior art multiport devices can only be measured by performing several sweeps and adjusting the optimum input polarization for each sweep. Another solution would be to insert a one dimensional polarization controller (i.e. a wave plate of tunable retardation) in front of each PDR. This gives the opportunity to acquire all data in a single or at least in two scans.

According to an embodiment of the present invention a replacement of a PDR by a polarization multiplexed LO signal solves this problem since no special absolute orientation of the polarization states SOP_{H} and SOP_{V} are required.

Other preferred embodiments are shown by the dependent claims.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIG. 1 is a schematic diagram displaying a way how to generate signals according to an embodiment of the present invention;

FIG. 2 is a graph showing two spectral components occurring in the electrical spectrum corresponding to two elements of the Jones matrix according to an embodiment of the present invention;

FIG. 3 shows a setup for multiport device characterization according to an embodiment of the present invention;

FIG. 4 shows a setup for single-scan multiport device characterization according to an embodiment of the present invention; and

FIG. 5 is a graph showing resulting spectral components when using the embodiment of FIG. 4.

### DETAILED DESCRIPTION OF THE INVENTION

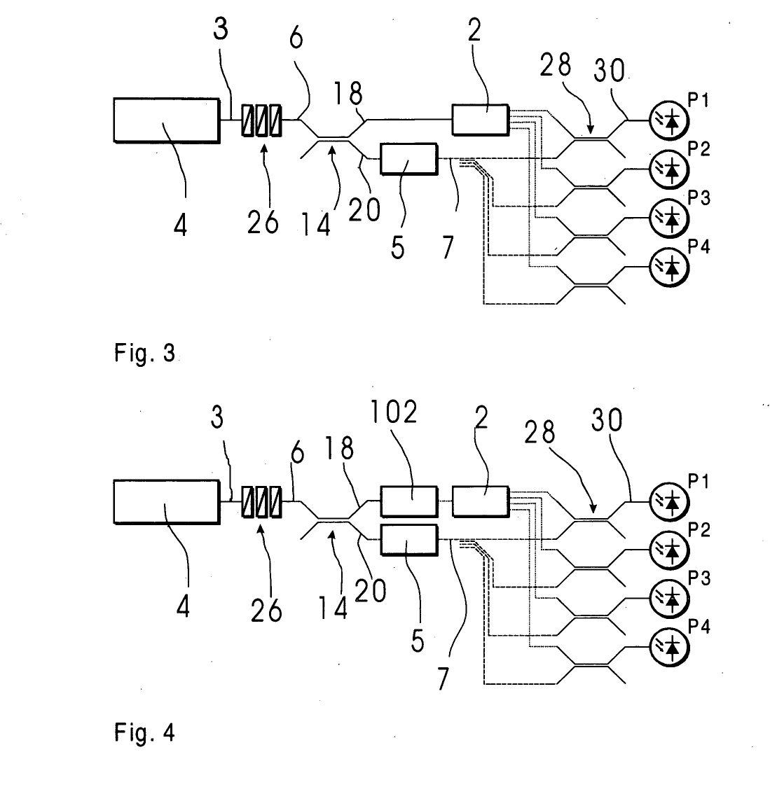

Embodiment of FIG. 3 shows a possible implementation of a measurement setup for multiport device characterization according to an embodiment of the present invention. A LO signal 3 coming from a tunable laser source (TLS) 4 is adjusted in its polarization to a defined polarization by a polarization setting tool 26 positioned in the path of the light beam 3 before a first beam splitter 14. The resulting incoming light beam 6 is split by the first beam splitter 14 into a first light beam 18 and a second light beam 20.

An optical device under test 2 is positioned in a first path of the first light beam 18 for coupling in the first light beam 18. A LO polarization delay unit 5 is positioned in a second path of the second light beam 20 for coupling in the second light beam 20 for splitting the second light beam 20 into a first part and a second part, delaying the second part of the second light beam 20 relative to the first part of the second light beam 20, and recombining the first and the second part of the second light beam 20 to a resulting recombined beam 7.

A second beam splitter 28 in said first and in said second path for superimposing the first light beam 18 and the recombined beam 7 with the recombined parts of the second light beam 20 to produce interferences between the first light beam 18 and the recombined parts of the second light beam 20 in at least one resulting superimposed light beam 30 traveling a resulting path.

A detector P1 in said resulting path is then detecting the power of the resulting superimposed light beam 30 traveling the resulting path as a function of frequency and polarization when tuning the frequency of the incoming light beam 6 over a given frequency range with the TLS 4. Then, a (not shown) evaluation unit derives optical properties of the optical device under test 2 from the frequency dependency of the detected powers.

Since the PDU 5 is a multiport device the resulting beam 7 coming from the PDU 5 is distributed to four identical beam splitters 28. Accordingly, beam 18 is distributed to the four beam splitters 28. Leaving beam splitters 28 are four superimposed beams 30 which are detected by four receivers P1, P2, P3, P4 in the above described manner.

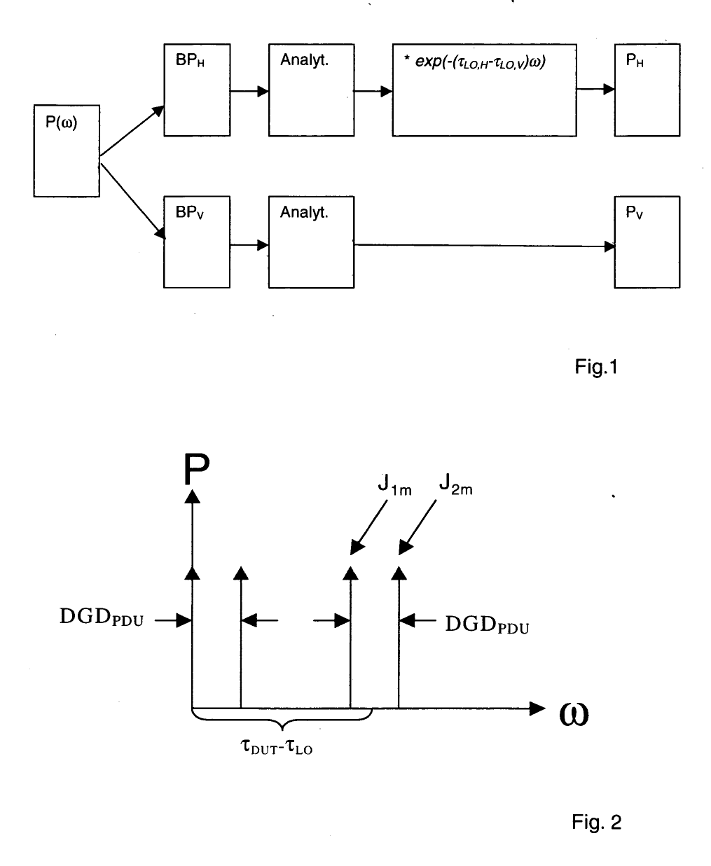

The received detector signal can be processed using the filtering setup of FIG. 1. FIG. 1 is a schematic diagram displaying a way how to generate signals according to an embodiment of the present invention. According to FIG. 3 the polarization controller 26 at the input of the system can adjust the input polarization of the PDU 5 appropriately so that the two propagation paths are excited with the same optical power. For the two-scan method according to EP 1113250, preferably two scans with orthogonal polarizations are performed. The equal power splitting inside the PDU 5 is maintained even if the input polarization is adjusted to the orthogonal state. The setup displayed in FIG. 3 has a significant reduced complexity and can be enhanced to more than four ports without any further considerations.

Because the PDU 5 is introduced into the LO path, two orthogonal polarization states, a first state of polarization SOP_{H} and a second state of polarization SOP_{V}, occur at the output of the PDU 5. The two orthogonal components have traveled different optical paths inside the PDU 5 and thus produce interference signatures at different electrical frequencies f_{H} and f_{V} according to FIG. 2 when combined with the DUT signal 18 at the detectors P1-P4. FIG. 2 is a graph showing two spectral components occurring in the electrical spectrum corresponding to two elements of the Jones matrix.

These spectral components or interference signatures created by the interference of the DUT signal 18 with signals SOP_{H} and SOP_{V} respectively can be distinguished preferably by applying band pass filters of appropriate center frequency and bandwidth.

Furthermore, amplitude and phase of the two spectral components only depend on the fraction of the DUT signal 18 having the same polarization as the interfering LO signal 7. That is, the DUT signal 18 is inherently decomposed into two polarizations SOP_{H} and SOP_{V} interfering with the corresponding two LO signals 7 and producing signatures at f_{H} and f_{V} respectively. The AC part of the detector signal can be written as follows:

$$\begin{matrix}{P}_{AC} ( ω ) = {E}_{LO} {E}_{DUT} ( {\vec{sop}}_{DUT} \cdot {\vec{sop}}_{H} ) cos ( {φ}_{H} + {( {τ}_{DUT} - {τ}_{LO , H} )}_{{1 \; 4 \; 4 \; 2 \; 4 \; 43 }_{{f}_{H}}} ω ) + \\ {E}_{LO} {E}_{OUT} ( {\vec{sop}}_{DUT} \cdot {\vec{sop}}_{V} ) cos ( {φ}_{V} + {( {τ}_{DUT} - {τ}_{LO , V} )}_{{1 \; 4 \; 4 \; 2 \; 4 \; 43 }_{{f}_{V}}} ω )\end{matrix}$$

To produce a signal which can be processed in the established way by the Jones matrix eigenanalysis, the two spectral components can be separated using two FIR filters according to the scheme displayed in FIG. 1. The faster oscillating signal can be shifted in frequency so that it is aligned to the slower oscillating signal. This can easily be achieved if the DGD of the PDU is known, with DGD_{PDU}=τ_{LO,H}−τ_{LO,V}. Then a linear phase term can be subtracted from the analytical signal by multiplying with exp(−(τ_{LO,H}−τ_{LO,V})ω). According to FIG. 1 the two generated signals are identical to those which would have been generated by a coherent prior art PDR detector.

The method according to this embodiment is compatible to the single-scan measurement concept described in U.S. Ser. No. 09/940,741, the priority of which is claimed by the present application and the disclosure of which is incorporated herein by reference.

If an additional but identical PDU 102 is inserted into the DUT path according to an embodiment of FIG. 4 showing a setup for characterizing a DUT 2 with four output ports P1-P4 using the single-scan approach, four interference signatures are generated at the receivers P1-P4. However, the DGD values of the two PDUs 5 and 102 have to be chosen appropriately to ensure that the four spectral components do not intersect. Equidistant frequency components can be generated if the two DGD values, hereafter referred to as DGD_{PDULO} and DGD_{PDUDUT}, differ by a factor of two. Furthermore, frequency components can be generated in the low-frequency range which can easily be removed by a high-pass filter.

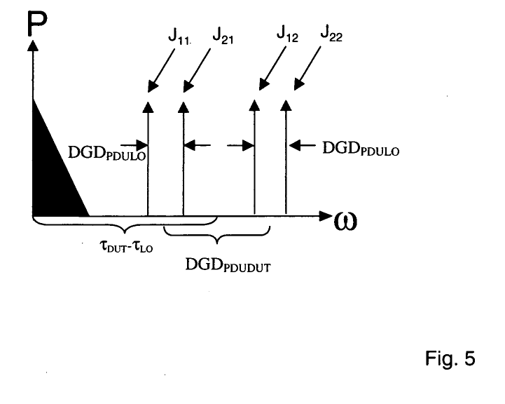

FIG. 5. shows the resulting spectral components of the electrical spectrum. The four components J₁₁, J₂₁, J₁₂, J₂₂ correspond to the four elements of the Jones matrix. They can be separated in the same way as it is done according to FIG. 1, and three of the four components J₁₁, J₂₁, J₁₂, J₂₂ can be shifted in frequency to be realigned with the first component J₁₁. At this point the established Jones matrix eigenanalysis can be applied to the four signals to derive information on PMD of DUT 2.

1. A method of determination of a property of an optical device under test, comprising:
splitting an incoming light beam into a first light beam and a second light beam,
coupling the first light beam into the optical device under test,
letting the second light beam travel a different path as the first light beam,
splitting the second light beam into a first part and a second part,
delaying the second part of the second light beam relative to the first part of the second light beam,
recombining the first and the second part of the second light beam,
superimposing the first light beam and the recombined parts of the second light beam to produce interferences between the first light beam and the recombined parts of the second light beam in at least one resulting superimposed light beam,
detecting the power of the at least one superimposed light beam as a function of frequency and polarization when tuning the frequency of the incoming light beam over a given frequency range, and
deriving the optical property of the optical device under test from the frequency dependence of the detected powers.

2. The method of claim 1, further comprising
deriving elements of the Jones matrix for the optical device under test from the frequency dependence of the detected powers.

3. The method of claim 1, further comprising:
changing the polarization of the first light beam with respect to a original polarization of the first light beam into a changed polarization, preferably said changed polarization being orthogonal to said original polarization, and
performing claim 1 a second time with said changed polarization.

4. The method of claim 1, further comprising:
splitting the first light beam into a first part and a second part,
delaying the second part of the first light beam relative to the first part of the first light beam,
recombining the first and the second part of the first light beam, and
coupling the recombined parts of the first light beam with different polarizations into the optical device under test.

5. The method of claim 1,
whereby the polarizations of at least one of the following being at least approximately orthogonal to each other: the first and second parts of the first light beam, the first and second parts of the second light beam.

6. The method of claim 1,
whereby each recombined part of at least one of the following has at least approximately 50% of the power of the incoming light beam: each recombined part of the first light beam, each recombined part of the second light beam.

7. The method of claim 1, further comprising:
filtering a peak in the spectrum of detected powers, preferably by a band pass filter,
allocating the peak in the spectrum to the respective part, and
deriving optical properties of the optical device under test from the frequency and polarization dependence of the detected powers.

8. The method of claim 1, further comprising:
producing interference between the recombined parts of at least one of the following in a resulting superimposed light beam: the first and second parts of the first light beam, the first and second parts of the second light beam,
continuously detecting the power of the resulting superimposed light beam as a function of frequency when tuning the frequency of the incoming light beam over a given frequency range,
detecting a nonlinearity in a tuning gradient frequency when tuning the frequency of the incoming light beam over the given frequency range, and
when detecting a nonlinearity, using said detected nonlinearity information to compensate effects on the detected powers.

9. The method of claim 8, further comprising:
producing interference by polarizing the recombined parts.

10. The method of claim 1, further comprising at least one of the following:
deriving the polarization mode dispersion of the device under test from the information obtained through the measurement, preferably represented as Jones matrix elements of the device under test,
deriving the chromatic dispersion of the device under test from the Jones matrix elements of the device under test,
deriving the principal states of polarization of the device under test from the Jones matrix elements of the device under test,
deriving the polarization dependent loss of the device under test from the Jones matrix elements of the device under test,
deriving the fast and slow group delays, associated with the fast and slow principal states of polarization of the device under test from the Jones matrix elements of the device under test,
deriving the insertion loss of the device under test from the Jones matrix elements of the device under test,
deriving the transmissivity of reflectivity of the device under test from the Jones matrix elements of the device under test,
deriving higher-order polarization mode dispersion parameters, such as the rate of change of the differential group delay with frequency, from the Jones matrix elements of the device under test.

11. The method of claim 1, further comprising
splitting at least one of the following into a first and a second part in a polarization dependent manner: the first light beam, the second light beam.

12. The method of claim 1, further comprising:
separating the spectral components of each of the recombined parts by using two band pass filters, preferably FIR filters, to produce a signal to be processed by a Jones matrix eigenanalysis, and shifting either the faster or the slower oscillating signal of the spectral components in frequency so that it is aligned to the other oscillating signal, preferably by using the differential group delay DGD_{PDU}=τ_{LO,H}−τ_{LO,V} of the PDU, τ_{LO,H} being the DGD of one spectral component, τ_{LO,V} being the DGD of the other spectral component, preferably performing the shift in frequency by subtracting a linear phase term from the analytical signal by multiplying with exp(±(τ_{LO,H}−τ_{LO,V})ω), ω being the frequency of the incoming light beam.

13. The method of claim 1, further comprising:
choosing a DGD value when delaying the second part of the second light beam relative to the first part of the second light beam relative to a DGD value or vice versa when delaying the second part of the first light beam relative to the first part of the first light beam in a way ensuring that respective spectral components of each part do not intersect.

14. An apparatus for determination of optical properties of an optical device under test, comprising:
a first beam splitter in a path of an incoming light beam for splitting the incoming light beam into a first light beam traveling a first path and a second light beam traveling a second path, wherein
the optical device under test can be coupled in said first path for coupling in the first light beam,
a LO polarization delay unit for:
splitting the second light beam into a first part and a second part,
delaying the second part of the second light beam relative to the first part of the second light beam,
recombining the first and the second part of the second light beam,
a second beam splitter in said first and in said second path for superimposing the first light beam and the recombined parts of the second light beam to produce interferences between the first light beam and the recombined parts of the second light beam in at least one resulting superimposed light beam traveling a resulting path,
a detector unit in said resulting path for detecting the power of the resulting superimposed light beam traveling the resulting path as a function of frequency and polarization when tuning the frequency of the incoming light beam over a given frequency range, and
an evaluation unit for deriving optical properties of the optical device under test from the frequency dependency of the detected powers.

15. The apparatus of claim 14 comprising an evaluation unit for deriving elements of the Jones matrix of the optical device under test from the frequency dependence of the detected powers.

16. The apparatus of claim 14,
further comprising a polarization setting tool positioned in said first path for adjusting the polarization of the first light beam to a defined polarization,
wherein the polarization setting tool is positioned in the path of the incoming light beam before or after the first beam splitter.

17. The apparatus of claim 16,
wherein the polarization setting tool is adjusting the polarization of the respective beam in a linear manner.

18. The apparatus of claim 14,
further comprising: a DUT polarization delay unit for:
splitting the first light beam into a first part and a second part,
delaying the second part relative to the first part,
recombining the first and the second part,
providing the recombined parts with different polarizations for coupling into the optical device under test.

19. The apparatus of claim 14,
wherein at least one of the following comprises a first polarization beam splitter for splitting the first light beam into a first part and a second part: the LO the polarization delay unit, the DUT polarization delay unit.

20. The apparatus of claim 14,
wherein at least one of the following comprises a second polarization beam splitter for recombining the first part and the second part: the LO polarization delay unit, the DUT polarization delay unit.

21. The apparatus of claim 14,
wherein at least one of the following comprises a first optical path for the first part and a second optical path for the second part, the second path having a longer optical length than the first path, for delaying the second part relative to the first part: the LO polarization delay unit, the DUT polarization delay unit.

22. The apparatus of claim 14,
wherein at least one of the following comprises a polarizing device for providing each of the recombined parts with different polarizations: the LO polarization delay unit, the DUT polarization delay unit.

23. The apparatus of claim 14,
wherein at least one of the following comprises a device for providing the recombined parts with different polarizations to a polarizer to produce interference between the parts in a resulting superimposed light beam traveling a resulting path:
the LO polarization delay unit, the DUT polarization delay unit,
the apparatus further comprising a power detector in said resulting path for detecting the power of the resulting superimposed light beam as a function of frequency when tuning the frequency of the incoming light beam over a given frequency range,
whereby an output of the power detector is connected with the evaluation unit for detecting any nonlinearity in a tuning gradient frequency when tuning the frequency of the incoming light beam over the given frequency range, and in case evaluation unit is detecting any nonlinearity, the evaluation unit is using said detected nonlinearity information to compensate effects on the detected powers caused by said nonlinearity.

24. The apparatus of claim 23,
wherein the device is at least one of the following:
an output port of the second polarization beam splitter not to be connected with the optical device under test,
a polarization maintaining coupler to be connected with the output port of the second polarization beam splitter to be connected with the optical device under test,
at least one beam splitter to be connected with the output port of the second polarization beam splitter to be connected with the optical device under test.
